(19) United States
(12) Patent Application Publication
(10) Pub. No.: US 2005/0216473 A1
(43) Pub. Date: Sep. 29, 2005

(54) P2P network system

(76) Inventors: Yoshio Aoyagi, Yokohama (JP); Takashi Iwasaki, Yokohama (JP); Katsuichi Nakamura, Tosu (JP); Seiji Nomiyama, Yokohama (JP); Akira Imahase, Yokohama (JP)

Correspondence Address: KATTEN MUCHIN ROSENMAN LLP, 575 MADISON AVENUE, NEW YORK, NY, 10022-2585, US

(21) Appl. No.: 10/957,184

(22) Filed: Sep. 30, 2004

(30) Foreign Application Priority Data
Mar. 25, 2004 (JP) 2004-089917

(51) Int. Cl. G06F 7/00

(52) U.S. Cl. 707/10

(57) ABSTRACT

A peer node according to the present invention relates to a peer node for constructing a peer-to-peer (P2P) network allowing P2P type communication. The peer node includes a unit dividing a share target file for information sharing through the P2P network into a plurality of divided files in a form where contents of each divided file makes no sense by itself; a unit distributing and arranging the plurality of divided files to and in a plurality of peer nodes including the own peer node and at least one other peer node constituting the P2P network; and a unit moving each of the divided files of distribution and arrangement between the plurality of peer nodes at a certain period of time.

### BACKGROUND OF THE INVENTION

The present invention relates to a P2P (peer-to-peer) network system having a function of maintaining the security of a shared file, and more particularly to a technology for maintaining the security of a shared file (share target file) held in peers (peer nodes or peer computers) constituting a P2P network for information distributed sharing under a collaboration P2P application environment that supports collaboration between multiple users on the P2P network and realizes efficient collaboration.

Generally, communication through the Internet is carried out between clients and servers. In the case of browsing of Web (World Wide Web (WWW)) pages, for instance, personal computers that are attempting to browse the Web pages are the clients and computers holding the Web pages to be displayed are the servers (Web servers). The servers wait for access from the clients at all times and communication is started by connection from the clients to the servers.

In recent years, however, along with the widespread proliferation of Always On broadband lines, the improvements of the performances of personal computer, and the increases of the disk capacities (storage capacities) of the personal computers, there occur server bottleneck problems in the client/server model (client/server type communication network). Consequently, attention is focused on a P2P model (peer-to-peer type communication network or P2P network) that is an architecture where no server is required. Also, many P2P applications that support collaboration on the P2P network are published and information sharing (such as file sharing) utilizing the P2P applications is increasingly performed.

Here, as conventional techniques, (1) the P2P and (2) the security of a shared file in the client/server model will be described.

(1) P2P

The term “P2P” stands for “peer-to-peer” and the term “peer” has a meaning of “on equal terms”. In the P2P, every computer is on an equal footing and changes its position to a server in some cases and to a client in other cases. The P2P is a framework for contents sharing utilizing resources of peers (peer nodes or peer computers) dynamically connected to the Internet and realizes distributed sharing instead of centralized sharing. Major features of the P2P resides in that it is possible to perform access without paying attention to the locations of contents and that it is possible to take part in contents sharing with ease.

The Advanced Research Projects Agency Network (ARPANET) that is said as the origin of the Internet was a distributed type network and adopted a mode where it was possible for every computer to perform mutual communication on equal terms. As a result of the widespread proliferation of the Internet, which was started by the public use of the WWW, however, the mutual connection form has been lost because it becomes sufficient that each computer operates as a client and it becomes unnecessary for the computer to function as a server.

Nowadays, the performances of computers are dramatically improved and the bandwidths of networks are also improved with the advent of the Asymmetric Digital Subscriber Lines (ADSLs) and the like. However, it is not a rare case where access is concentrated on popular sites and therefore servers fall into an overload state or networks are congested. As a technique of solving those problems, the P2P receives attention again.

As to the P2P, there are two major modes, one of which is the Hybrid P2P and the other of which is the Pure P2P. The Hybrid P2P is a mode where respective nodes (computers) on a network perform the exchange of data through mediation between the nodes and the like by a central server. This mode depends on the central server, so that there is a disadvantage in that the network is stopped at the time of server down but there is an advantage in that information management becomes easy. As a representative application, there is Napster for the exchange of music files.

In contrast to the Hybrid P2P, the Pure P2P is a mode where no central server is provided. Node information is held in each node itself and the exchange of data is performed only between respective nodes. This mode does not depend on any central server, so that there is a disadvantage in that the management of the node information and the like becomes complicated but there is an advantage in that even if a network is stopped partially, the network will never be stopped entirely. As a representative application, there is Gnutella that is used for the exchange of general-purpose files.

(2) Security of Shared File in Client/Server Model

As a technology for performing collaboration in the conventional client/server model, there is a method with which a shared file is held in a file server. In order to maintain the security of the file held in the file server, for instance, a user attempting to access the file server is authenticated, thereby preventing access from an unauthorized user. Also, the file itself held in the file server is encrypted, thereby preventing the contents of the file from being read even if the file is stolen.

As an example of the user authentication, there is the Source NFS in the Network File System (NFS). This NFS is a network service that allows computers to mutually share their file systems over a Transmission Control Protocol/Internet Protocol (TCP/IP) network.

The NFS has such a feature that it is possible to access the same file from multiple computers, which makes it possible to save a disk space. In addition, it is possible to collectively manage data, which facilitates management. Consequently, the NFS is widely used as a shared data area of a distributed system and many file servers utilizing the FNS are operated.

In the NFS, each user issued a request for a service is authenticated on a network by using the Source Remote Procedure Call (RPC) that is an authentication technology for the authentication of a host requesting the service and its user. This process is referred to as the Source NFS.

As to the encryption of files, there exist several encryption/decryption applications. In many cases, however, the files are encrypted by using information inherent in the files, random numbers, or passwords as key information and the encrypted files are decrypted by using the key information.

Aside from this, there is also a technique with which the key information used at the time of the encryption of files is subjected to certain processing and is embedded in the headers of the encrypted files. For instance, as a security technology for file sharing among multiple users, Japanese Patent Laid-Open Publication No. 2000-99385 (Patent document 1) proposes a technique with which multiple pieces of encryption key information are embedded in the header of each file, thereby making it possible to decrypt the file with the multiple pieces of key information.

In the client/server model, the file server rejects the access by each unauthorized user by using the user authentication technology, although the shared files are collectively managed in a stationary manner, so that once unauthorized access is performed, this results in a situation where a large number of files are leaked.

Also, even when files are held under an encrypted state, if key information used for the encryption is identified, it becomes possible to decrypt the files. In particular, when key information is embedded in the files or the decryption of the files is possible with multiple pieces of key information like in the case of Japanese Patent Laid-Open Publication No. 2000-99385, the probability that the encrypted files will be decrypted is increased.

On the other hand, in the case of file sharing under a collaboration P2P application environment operating in a P2P network, files to be shared (share target files) are distributed across respective peers, so that it becomes possible to avoid a situation where a large number of files are leaked at a time. Even in this case, however, there still remains a possibility that like in the case of a file server, files will be leaked through unauthorized access. Also, even if the leaked files are encrypted, there is a possibility that the files will be decrypted.

That is, as to such shared files held in peers under a collaboration P2P application environment operating in a P2P network, a technique for preventing peers holding files from being identified is required in order to prevent unauthorized access. In addition, a technique is also required with which even if files are leaked, it is possible to prevent the contents (information, data) of the files from being read.

The following are prior arts to the present invention.

[Patent Document 1]

Japanese Patent Laid-Open Publication No. 2000-99385
   [Patent Document 2]
Japanese Patent Laid-Open Publication No. 2003-167772

### SUMMARY OF THE INVENTION

An object of the present invention is therefore to provide a technique with which as to divided files of a share target file that are held in multiple peer nodes constituting a P2P network, it is possible to prevent the peer nodes holding the divided files from being identified, thereby preventing unauthorized access.

Another object of the present invention is to provide a technique with which even when a share target file is leaked, it is possible to prevent the contents of the file from being read.

To solve the problems described above, according to the present invention, a peer node for constructing a peer-to-peer (P2P) network allowing P2P type communication, includes a unit dividing a share target file for information sharing through the P2P network into a plurality of divided files in a form where contents of each divided file makes no sense by itself; a unit distributing and arranging the plurality of divided files to and in a plurality of peer nodes including an own peer node and at least one other peer node constituting the P2P network; and a unit moving each of the divided files of distribution and arrangement between the plurality of peer nodes at a certain period of time.

In this case, the dividing unit divides the share target file into at least one first divided file containing only even bits of file constituent data and at least one second divided file containing only odd bits of the file constituent data.

A peer node according to the present invention, further includes: an interface unit enabling registration of and a search for the share target file from a user terminal; a first management unit managing division information concerning the share target file inputted through the interface unit and divided by the dividing unit using a first storage unit; a first search unit performing, with respect to the share target file requested from the user terminal through the interface unit, a search of the first storage unit in the own peer node and creating a search message to be transmitted to the at least one other peer node; a first control unit exchanging the plurality of divided files of the share target file registered by the first management unit and the search message created by the first search unit with the at least one other peer node; a second search unit searching for transmission destination peer node information requested from the first control unit by using a second storage unit storing adjacent peer node information; a second management unit managing each divided file received by the first control unit using a third storage unit storing reception file information, judging whether each file transfer request from another peer node should be approved or rejected, and requesting the first control unit to transfer the received divided file when a current time has reached a transfer time set for the received divided file; and a restoration unit restoring the share target file based on the plurality of divided files collected by the first search unit.

A peer node according to the present invention, further includes: a third search unit searching, when the plurality of peer nodes are divided into a plurality of groups, for a transfer destination for each divided file by selecting one peer node from the same group, wherein the divided files are distributed to and arranged in the plurality of peer nodes, including the own peer node and at least one other peer node constituting the P2P network, every the plurality of groups and are moved to another peer node in the same group at a certain period of time.

In this case, the third search unit searches for transmission destination peer node information requested from the first control unit by using a fourth storage unit storing peer group information.

According to the present invention, under a collaboration P2P application environment operating in a P2P network, a share target file is divided into multiple divided files and the divided files are moved (transferred or circulated) on the P2P network, thereby preventing peers holding the files from being identified. As a result, it becomes possible to prevent the leakage of the files by unauthorized access.

Also, according to the present invention, a share target file is divided into multiple divided files and the divided files are held in multiple peer nodes, so that even when data leakage occurs due to unauthorized access or the loss and theft of any of mobile terminals (laptop personal computers, for instance) that constitute the peer nodes, it is impossible to restore the file. As a result, it becomes possible to maintain security.

Further, according to the present invention, load distribution is achieved through file sharing in the P2P model, so that it becomes possible to prevent a problematic situation occurring in the case of file sharing based on the client/server model, that is, a situation where a server falls into an overload state or traffic in a network is concentrated in a certain part of the network.

Other objects, features, and advantages of the present invention will become apparent from the following description to be made with reference to the accompanying drawings and the appended claims.

### BRIEF DESCRIPTION OF THE DRAWINGS

FIG. 1 is a block diagram showing constructions of a system and peers of an embodiment of the present invention;

FIG. 2 is an explanatory diagram of a share target file registration sequence;

FIG. 3 is an explanatory diagram of a share target file transfer sequence;

FIG. 4 is an explanatory diagram of a shared file search sequence;

FIG. 5 is a drawing for explaining a first specific example;

FIG. 6 is a drawing for explaining the first specific example;

FIG. 7 is a drawing for explaining the first specific example;

FIG. 8 is a drawing for explaining the first specific example;

FIG. 9 is a drawing for explaining the first specific example;

FIG. 10 is a drawing for explaining a second specific example;

FIG. 11 is a drawing for explaining the second specific example;

FIG. 12 is a drawing for explaining the second specific example;

FIG. 13 is a drawing for explaining the second specific example;

FIG. 14 is a drawing for explaining a third specific example;

FIG. 15 is a drawing for explaining the third specific example;

FIG. 16 is a drawing for explaining the third specific example;

FIG. 17 is a drawing for explaining the third specific example;

FIG. 18 is a drawing for explaining a fourth specific example;

FIG. 19 is a drawing for explaining the fourth specific example;

FIG. 20 is a drawing for explaining the fourth specific example;

FIG. 21 is a drawing for explaining the fourth specific example; and

FIG. 22 is a drawing for explaining the fourth specific example.

### DETAILED DESCRIPTION OF THE PREFERRED EMBODIMENTS

The present invention will now be described in more detail with reference to the accompanying drawings. The drawings illustrate a preferred embodiment of the present invention. However, it is possible to carry out the present invention in many different modes and it should not be construed that the present invention is limited to the embodiment described in this specification. If anything, the embodiment is provided in order to thoroughly and completely disclose the present invention and to sufficiently inform persons skilled in the art of the scope of the present invention.

[Construction of System and Peer]

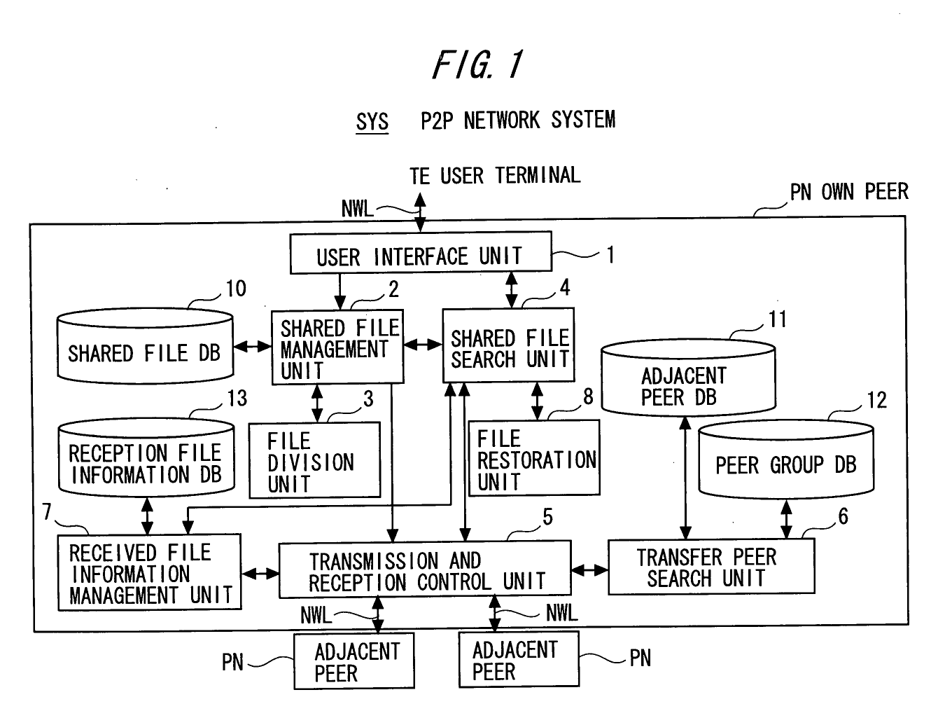

Referring to FIG. 1 showing constructions of a system and peers in an embodiment of the present invention, a P2P network system SYS has a function with which under an environment where a file is shared among multiple peers (peer nodes or peer computers) PN by utilizing a P2P network NW, a file to be shared (share target file) is divided into multiple files in units (contents unreadable units) in which it is impossible to read the contents (information, data) of the files, the respective files obtained through the division are distributed to the peers PN in the P2P network NW, and each distributed divided file is moved from one peer PN to another periodically (each time a predetermined certain period of time or a predetermined certain term has passed).

In this P2P network system SYS, the peers PN constituting the P2P network NW adopt the same construction, accommodate user terminals TE (not sown) through lines NWL of the P2P network NW, and are capable of establishing interconnection. In FIG. 1, a state is shown in which a peer PN denoted as the “own peer” is connected to other peers PN denoted as the “adjacent peers” through the lines NWL of the P2P network NW.

In each peer PN, user interface means (unit) 1 provides a user interface through which a user performs registration of a file to be shared and a search for the shared file from his/her user terminal TE. Shared file management means 2 manages information concerning the shared file registered by the user from the user terminal TE through the user interface means 1 by using a shared file information database (shared file DB) 10.

Also, in each peer PN, file division means 3 divides the file to be shared registered through the shared file management means 2 into multiple files in the contents unreadable units. Shared file search means 4 searches the shared file DB 10 in the own peer for the divided files of the shared file and creates a search message to the other peers (adjacent peers) in response to a request made by the user using the user terminal TE through the user interface means 1. Transmission and reception control means 5 exchanges the divided files of the share target file registered by the shared file management means 2 and the search message created by the shared file search means 4 with the other peers.

Further, in each peer PN, transfer peer search means 6 has a function of searching for transmission destination peer information requested from the transmission and reception control means 5 by using an adjacent peer information database (adjacent peer DB) 11 and a peer group information database (peer group DB) 12. Reception file information management means 7 manages each divided file received by the transmission and reception control means 5 by using a reception file information database (reception file information DB) 13 and judges whether a file transfer request from another peer should be approved or rejected. In addition, when the current time has reached a transfer time set for a received divided file, the reception file information management means 7 requests the transmission and reception control means 5 to transfer the received divided file to another peer. File restoration means 8 restores the shared file based on the divided files collected by the shared file search means 4.

[Basic Operation of System and Peer]

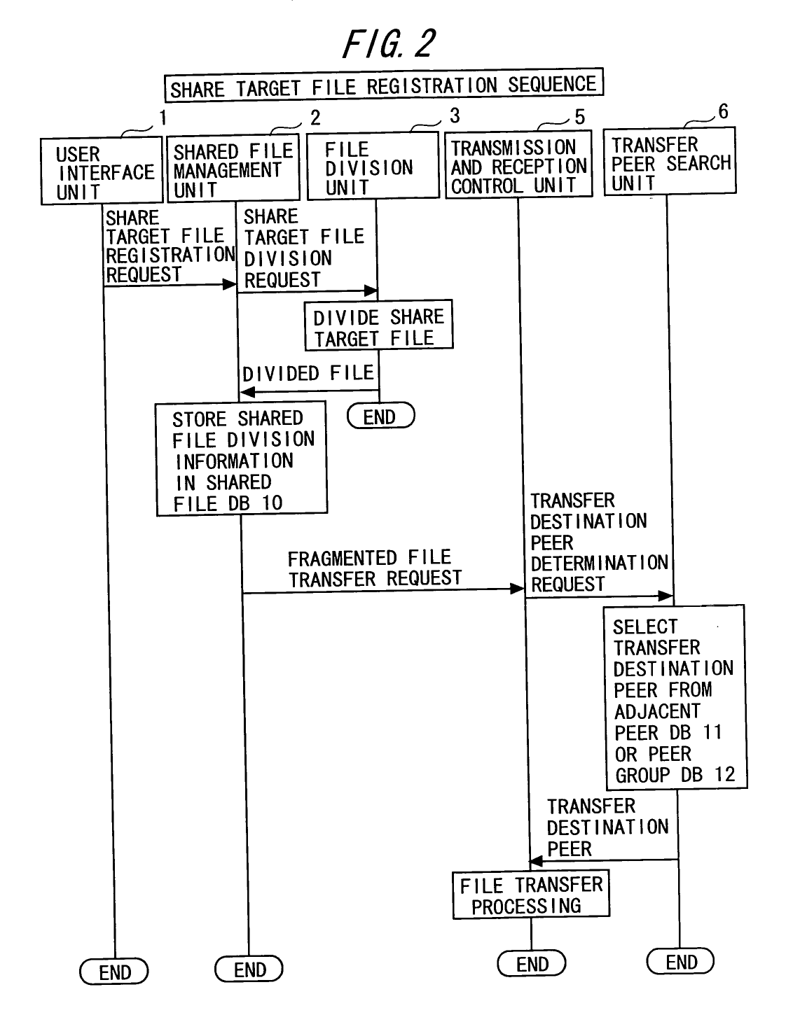

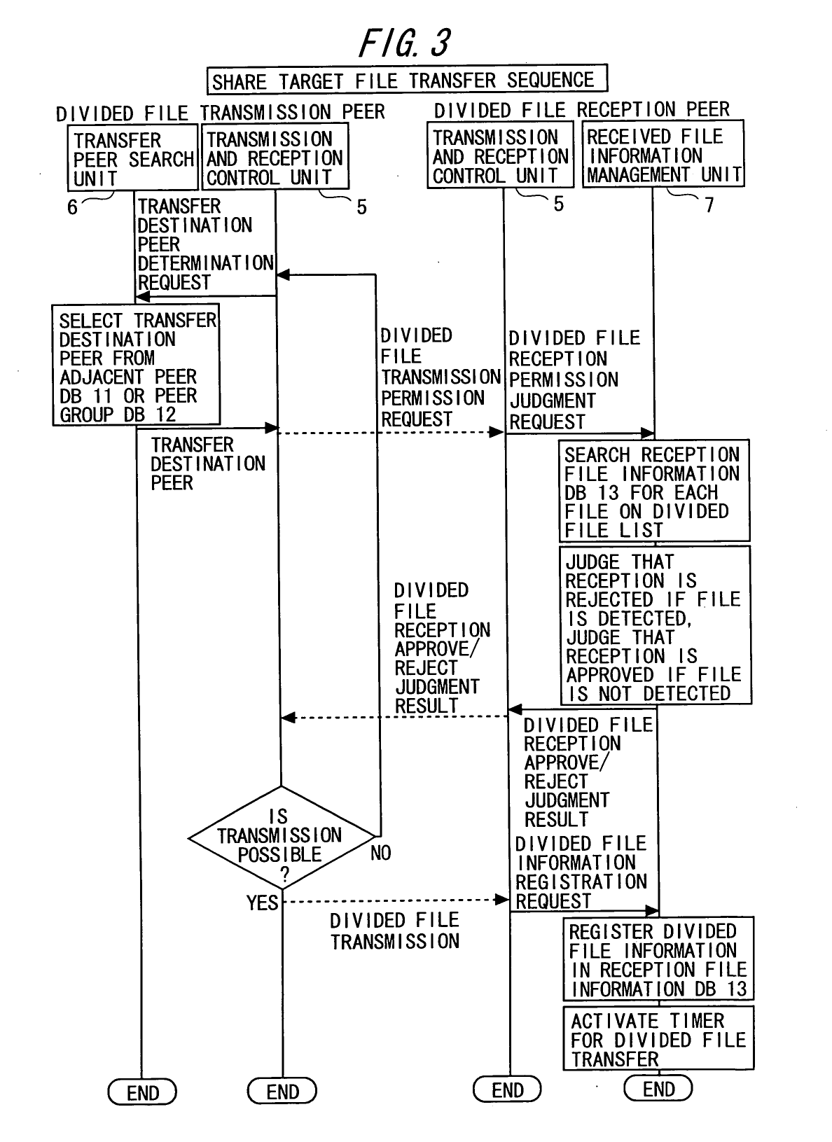

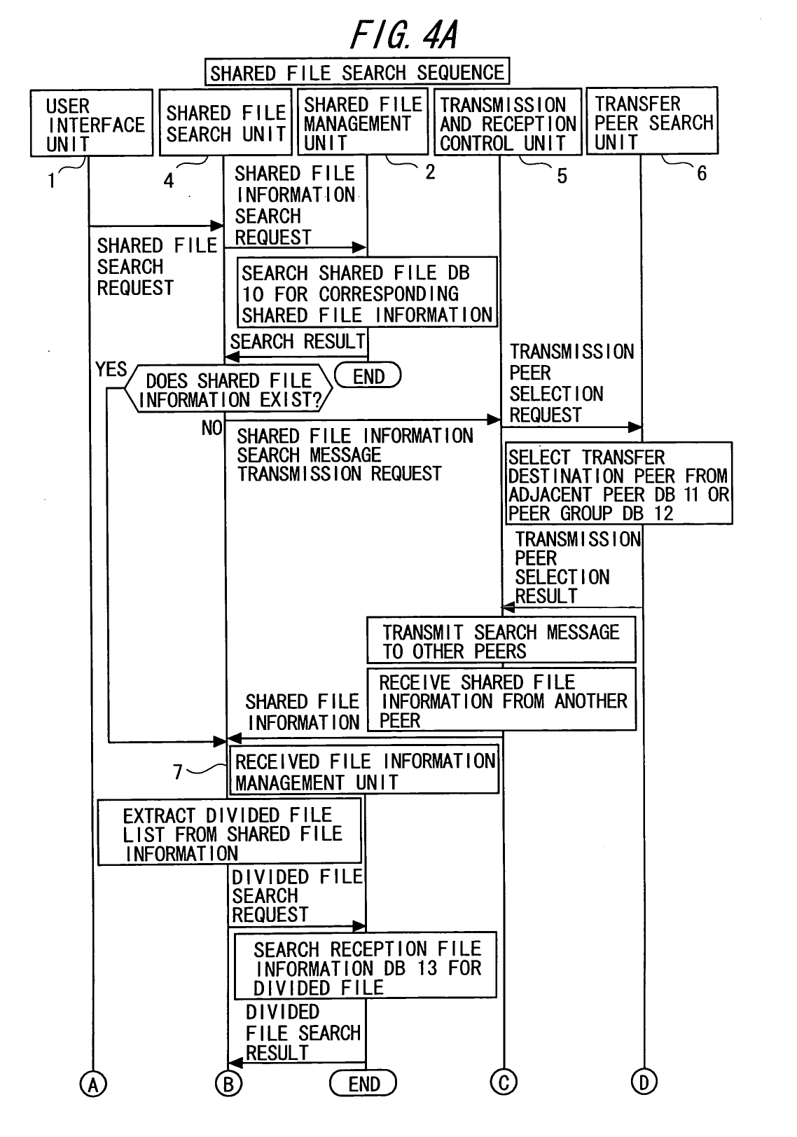

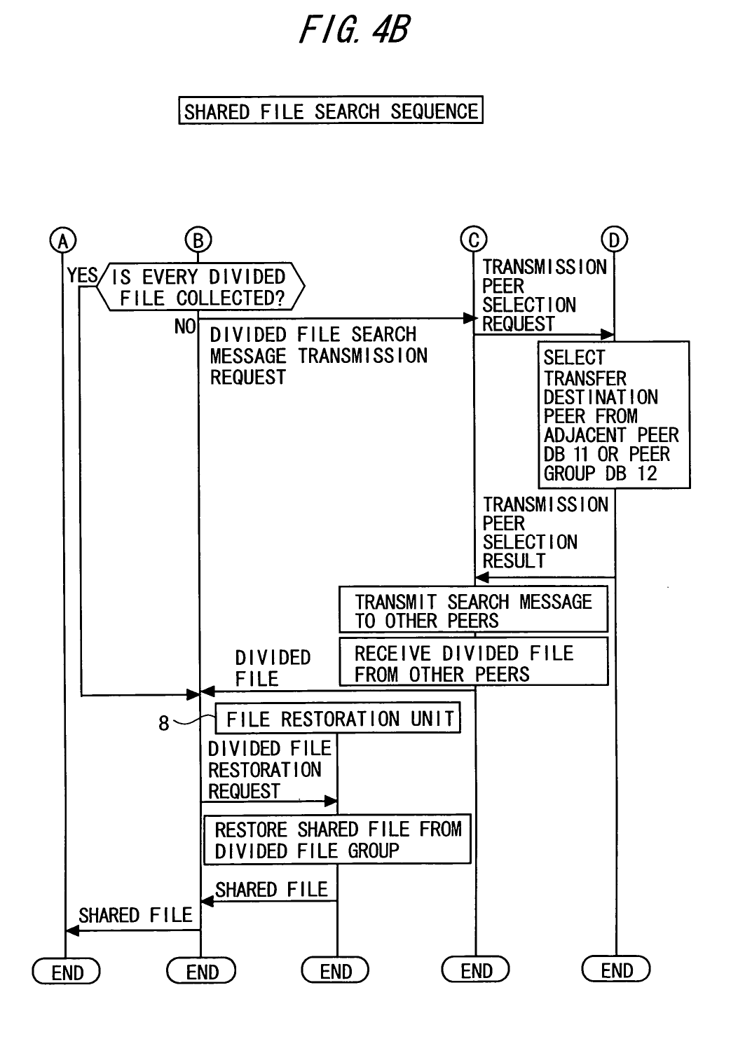

Next, an example of a basic operation in the P2P network system SYS according to one embodiment of the present invention shown in FIG. 1 will be described. FIG. 2 shows a sequence where a file to be shared is registered, FIG. 3 shows a sequence where divided files of the share target file are transferred, and FIG. 4 shows a sequence where the shared file is searched for.

First, the share target file registration sequence in the P2P network system SYS according to one embodiment of the present invention will be described with reference to FIGS. 1 and 2.

When the user interface means 1 issues a share target file registration request to the shared file management means 2 in response to a request from the user by using the user terminal TE, the shared file management means 2 issues a share target file division request to the file division means 3 in order to divide a share target file to be registered. In response to this share target file division request, the file division means 3 performs file division processing and returns the processing of divided files to the shared file management means 2. At this time, the pre-division file may be encrypted in order to further enhance security. Then, the shared file management means 2 stores shared file division information, which shows how the file has been divided in the file division means 3, in the shared file DB 10.

Next, the shared file management means 2 issues a fragmented file transfer request to the transmission and reception control means 5 in order to transfer the fragmented files obtained through the division to the multiple other peers PN. In response to this request, the transmission and reception control means 5 issues a transfer destination peer determination request to the transfer peer search means 6 in order to search for other peers PN to which it is possible to transfer the fragmented files. On receiving this request, the transfer peer search means 6 searches for transfer destination peers with reference to the adjacent peer DB 11 or the peer group DB 12 and returns a result of this search to the transmission and reception control means 5 as the transfer destination peers. After the transfer destination peers are determined, the transmission and reception control means 5 performs file transfer processing.

Next, the sequence where the divided files of the share target file are transferred in the P2P network system SYS will be described with reference to FIGS. 1 and 3.

As shown in the sequence in FIG. 3, after the search for the transfer destination peers, the transmission and reception control means 5 issues a divided file transmission permission request to the transfer destination peers through the lines NWL of the P2P network NW. In each divided file reception peer that has received the divided file transmission permission request, the transmission and reception control means 5 issues a divided file reception permission judgment request to the reception file information management means 7 and passes the processing to the reception file information management means 7, which then judges whether it is possible to receive the divided file.

In more detail, the reception file information management means 7 searches the reception file information DB 13 for each file on a divided file list and returns a divided file reception approve/reject judgment result to the transmission and reception control means 5 of the divided file transmission peer. Here, if the divided file has already been received, the divided file reception approve/reject judgment result is set so as to show that the reception is rejected; if not, the divided file reception approve/reject judgment result is set so as to show that the reception is approved.

The transmission and reception control means 5 of the divided file transmission peer judges whether the transmission is possible with reference to the divided file reception approve/reject judgment result. Then, if the reception is rejected, the transmission and reception control means 5 performs the transfer destination peer search again. On the other hand, if the reception is approved, the transmission and reception control means 5 transmits the divided file to the divided file reception peer, in which the transmitted divided file is registered in the reception file information management means 7 through the transmission and reception control means 5. The registration processing performed in the reception file information management means 7 includes the accumulation of the file in the reception file information DB 13 and the activation of a timer for divided file transfer in order to hold the file only for a certain period of time.

Next, the sequence where the divided files of the shared file are searched for in the P2P network system SYS will be described with reference to FIGS. 1 and 4.

The user interface means 1 issues a shared file search request to the shared file search means 4. In response to this request, the shared file search means 4 issues a shared file information search request to the shared file management means 2 in order to extract corresponding shared file information. On receiving this request, the shared file management means 2 searches the shared file DB 10 for the corresponding file information and returns a result of this search to the shared file search means 4.

When the shared file information does not exist in the own peer, the shared file search means 4 next searches other peers PN for the shared file information. To do so, the shared file search means 4 searches for the other peers PN through the transmission and reception control means 5, issues a search message transmission request to the peers PN obtained as a result of the search, and extracts the shared file information. As a result of those operations, even when the shared file information does not exist in the own peer, it is possible to obtain the shared file information. Then, the processing proceeds to the next operation.

The shared file search means 4 extracts a divided file list from the shared file information and issues a divided file search request to the reception file information management means 7. In response to this request, the reception file information management means 7 searches the reception file information DB 13 for the divided files and returns a result of this search to the shared file search means 4. Then, divided file collection from another peer PN is repeated until every divided file is obtained. Following this, the shared file search means 4 issues a divided file restoration request to the file restoration means 8 and the file restoration means 8 restores the original file.

### FIRST SPECIFIC EXAMPLE

Next, a first specific example in the P2P network system SYS according to one embodiment of the present invention shown in FIG. 1 will be described.

As the first specific example, a file division and sharing technique will be described with which under a condition where the multiple peers PN are not grouped, a share target file (file to be shared) is divided/transferred and shared in the P2P network NW allowing peer-to-peer type communication between the multiple peers PN.

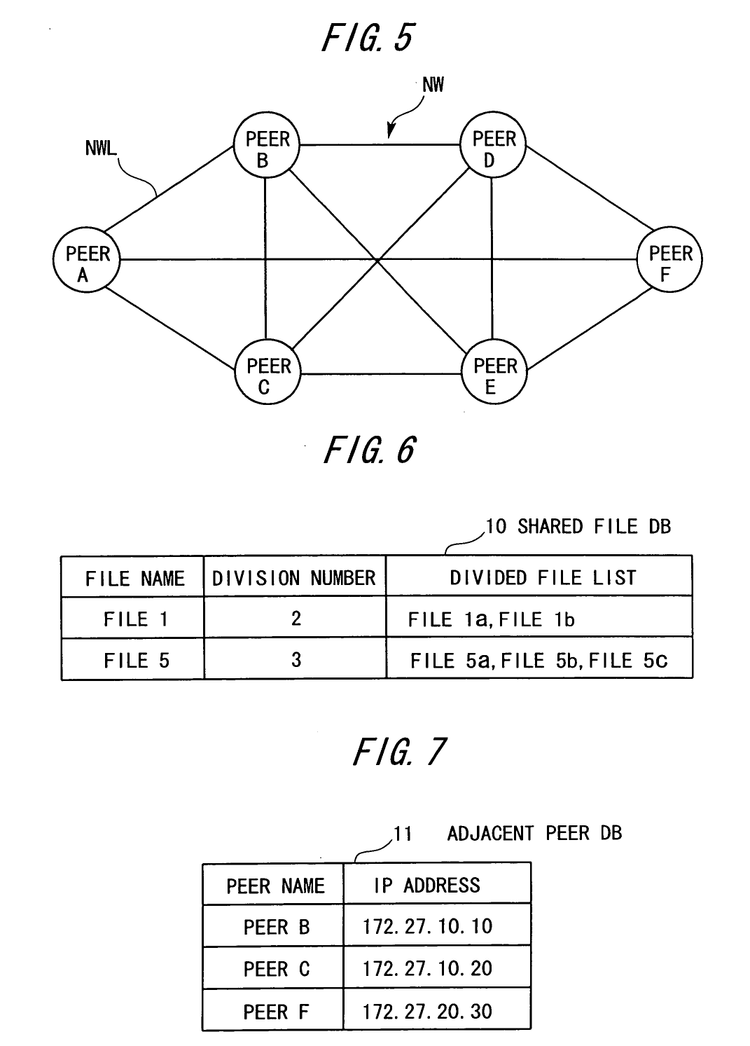

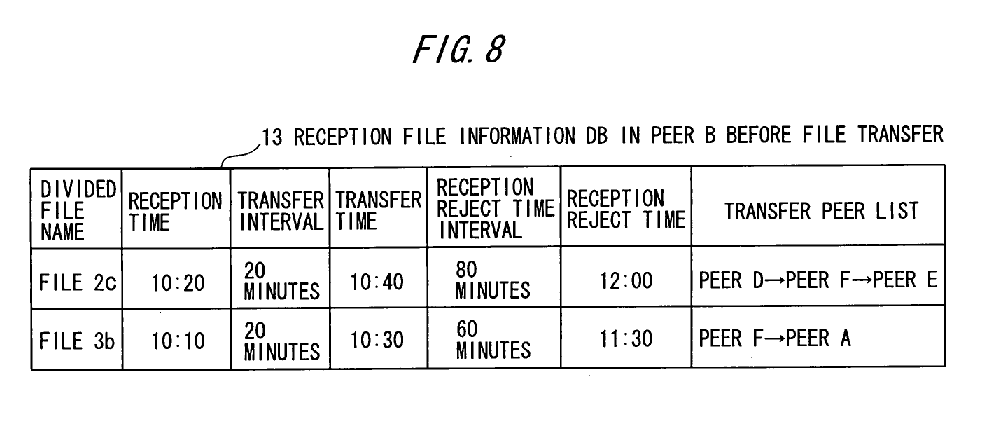

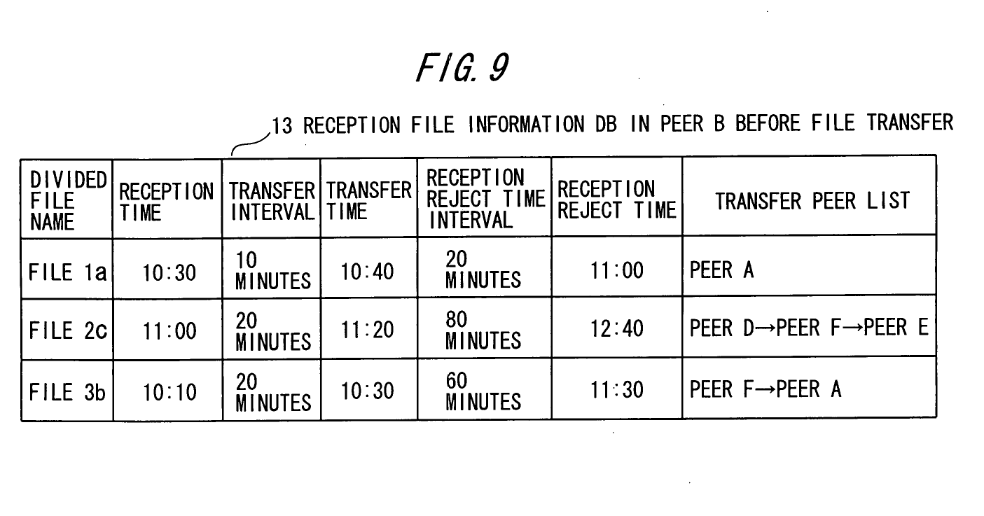

This file division and sharing technique will be described with reference to a construction of the P2P network NW shown in FIG. 5, a construction of the shared file DB 10 shown in FIG. 6, a construction of the adjacent peer DB 11 shown in FIG. 7, and a construction of the reception file information DB 13 shown in FIGS. 8 and 9 as well as FIGS. 1 to 4.

In this example, it is assumed that the peer A divides a share target file, thereby starting processing for sharing the file. Also, it is assumed that each peer A to F is not allowed to possess (save) two or more files (divided files or fragmented files) obtained through the division of the share target file at the same time. Further, it is assumed that for a predetermined certain period of time after the reception of a divided file of the share target file, it is impossible to receive the same divided file or another divided file.

(1) Division of File (in Peer A)

When a user using a user terminal TE accommodated in the peer A wishes to share a file FL 1 (file 1) while maintaining the security of this file 1, he/she instructs the shared file management means 2 to share the file 1 from the user terminal TE through the user interface means 1. Then, the shared file management means 2 requests the file division means 3 to divide the file 1.

Fundamentally, the file division means 3 divides the share target file in a form where data (information) contained in each divided file makes no sense by itself. In this example, the file division means 3 divides the file 1 into a first file F1a (file 1a) corresponding to a result of extraction of only even bits of the file (more strictly, file constituent data) and a second file F1b (file 1b) corresponding to a result of extraction of only odd bits of the file.

Then, the file division means 3 adds a header to each of those divided files 1a and 1b. The information contained in this header is a file transfer time interval, a divided file reception reject time interval, a divided file list, and a transfer peer list. The file transfer time interval is a period of time between the reception of the divided file by a certain peer and the transfer to the next peer. The divided file reception reject time interval is a period of time during which it is impossible to receive any of the divided files generated through the division of the shared file after the last divided file transfer. As to the shared file 1 in this example, the file transfer time interval is set at “10 minutes” and the divided file reception reject time interval is set at “20 minutes”.

Also, the divided file list is a list of the divided files that are necessary to restore the shared file. In more detail, the file 1a and the file 1b are on this divided file list. The transfer peer list is a list of peers through which the divided file has passed as a result of transfer based on the file transfer time interval. In this example, previous three reception peers are saved on the transfer peer list, with the oldest reception peer being at the start of the list.

(2) Registration of File Division Information (in Peer A)

After the division of the share target file 1, the file division means 3 of the peer A passes the pre-division file (file 1) and the post-division files (files 1a and 1b) to the shared file management means 2. Then, the shared file management means 2 registers information concerning the divided files 1a and 1b of the file 1 in the shared file DB 10 (see FIG. 6).

The shared file DB 10 is a database giving the division information concerning each file provided by the own peer and shared in the P2P network NW. In the shared file DB 10, each division number is the number of divided files of a shared file and each divided file list is a list of the names of post-division files of a shared file. The divided file list is referred to at the time of restoration of the shared file.

When the registration of the file division information into the shared file DB 10 is completed, the shared file management means 2 deletes the pre-division file (file 1), passes the post-division files (files 1a and 1b) and the file division information to the transmission and reception control means 5, and requests the transfer of the divided files.

(3) Search for Transfer Destination Peer (in Peer A)

On receiving the divided file transfer request from the shared file management means 2, the transmission and reception control means 5 requests the transfer peer search means 6 to search for divided file transfer destination peers. In response to this request, the transfer peer search means 6 searches for the divided file transfer destination peers. In more detail, the transfer peer search means 6 randomly extracts peers, whose number is equal to the number of the divided files, from the adjacent peer DB 11 (see FIG. 7). The contents of the adjacent peer DB 11 are a list of Internet Protocol (IP) addresses of the adjacent peers B, C, and F that are each a peer whose existence is known by the peer A in advance and with which it is possible for the peer A to perform direct communication. In this example, at the time when the peer A takes part in the P2P network NW, the contents of the adjacent peer DB 11 are registered.

Then, the transfer peer search means 6 returns the peer names and IP addresses of the transfer destination peers, whose number is equal to the number of the divided files, to the transmission and reception control means 5. Following this, the transmission and reception control means 5 determines a transfer destination peer for each divided file with reference to the transfer destination peer information received from the transfer peer search means 6 and issues a file transfer request to the transfer destination peer. In this example, the transmission and reception control means 5 of the peer A transfers the divided file 1a to the adjacent peer B and transfers the divided file 1b to the adjacent peer C. Note that in the following description, only the transfer of the file 1a to the peer B will be explained.

(4) Transfer of File (Negotiation with Transfer Destination Peer B)

In order to request the transfer destination peer B to receive the divided file 1a, the transmission and reception control means 5 of the peer A transmits the header of the divided file 1a through the line NWL of the P2P network NW. After receiving the header of the divided file 1a, the transmission and reception control means 5 of the peer B passes the divided file list in the divided file header to the reception file information management means 7, which then confirms whether any of the divided files of the shared file 1 has already been received.

In more detail, the reception file information management means 7 refers to the reception file information DB 13 (see FIG. 8) and searches for each file name contained in the divided file list. The reception file information DB 13 is a database composed of multiple columns named “divided file name”, “file reception time”, “file transfer time interval (transfer interval)”, “file transfer time”, “file reception reject time interval”, “file reception reject time”, and “transfer peer list”. The reception file information DB 13 having this construction is used to manage the time of a received divided file transfer to the next peer and to determine whether the reception of a divided file of a certain shared target file is approved or rejected.

When the divided file names contained in the divided file list do not exist in the reception file information DB 13, this corresponds to a situation where none of the divided files of the share target file 1 is under reception or under reception rejection. Consequently, if the divided file names do not exist, the reception file information management means 7 of the peer B returns information showing that the file reception is approved to the transmission and reception control means 5. On the other hand, when any of the divided file names exists, this corresponds to a situation where any of the divided files of the share target file 1 is under reception or under reception rejection, so that the reception file information management means 7 returns information showing that the reception is rejected to the transmission and reception control means 5.

When receiving the information showing that the file reception is approved from the reception file information management means 7, the transmission and reception control means 5 returns a reception permission notification to the peer A. On receiving this reception permission notification from the transfer destination peer B through the line NWL, the transmission and reception control means 5 of the peer A transfers the divided file 1a to the peer B through the line NWL.

(5) Reception of File (Processing in Peer B)

After receiving the divided file 1a transmitted from the transmission and reception control means 5 of the peer A, the transmission and reception control means 5 of the peer B stores the received divided file 1a in a disk apparatus and then passes the file name, header information (file transfer time interval, divided file reception reject time interval, transfer peer list), and file reception time of the received file to the reception file information management means 7.

The reception file information management means 7 registers the received file name, file reception time, and header information (file transfer time interval, divided file reception reject time interval, and transfer peer list) of the received file as well as a transfer time and a reception reject time calculated from those information in the reception file information DB 13. An example of the reception file information DB 13 after this registration processing is shown in FIG. 9.

Then, the reception file information management means 7 activates a timer for transfer of the file 1a based on the file transfer time interval in the received file header. When this timer has timed out, the reception file information management means 7 passes the name and the transfer peer list of the divided file obtained from the reception file information DB 13 to the transmission and reception control means 5 and requests the transfer of the file 1a to another peer.

(6) Transfer of File (Processing in Peer B)

On receiving the transfer request issued as a result of the time-out of the timer for the transfer of the divided file 1a, the transmission and reception control means 5 of the peer B passes the transfer peer list to the transfer peer search means 6 and requests a search for the next transfer peer.

On receiving this request, the transfer peer search means 6 determines a transfer destination peer through the same processing as in (3) described above. Note that each peer contained in the transfer peer list is excluded from the candidates for the transfer destination peer. Also, when no peer other than the peers contained in the transfer peer list exists as the candidates for the transfer destination peer, a transfer peer at the start of the transfer peer list, that is, the oldest transfer peer is set as the transfer destination peer.

In this example, it is assumed that the transfer peer search means 6 has determined the adjacent peer D as the transfer destination peer. Therefore, the transfer peer search means 6 passes the peer name and IP address of the peer D to the transmission and reception control means 5. Then, the transmission and reception control means 5 performs the same processing as in (4) described above to thereby request the transfer destination peer D to judge whether the file transfer is approved or rejected.

If the transfer to the peer D is possible, the transmission and reception control means 5 adds the own peer B to the transfer peer list of the file 1a and then transfers the file 1a to the peer D. When the number of peers registered on the transfer peer list has already reached a registration limit number (“3” in this example), the transmission and reception control means 5 deletes the oldest peer before adding the peer B. After the transfer to the peer D is completed, the transmission and reception control means 5 deletes the divided file 1a saved in the disk apparatus.

In this manner, the divided file 1a is moved from one peer to another each time a certain period of time has passed. As a result, it becomes possible to secure security.

### SECOND SPECIFIC EXAMPLE

Next, a second specific example in the P2P network system SYS according to one embodiment of the present invention shown in FIG. 1 will be described.

As the second specific example, a file acquisition technique will be described with which a file divided/transferred and shared with the same file division and sharing technique as in the first specific example described above is searched for and acquired. Like in the first specific example, this second specific example will be described under a condition where the multiple peers PN in the P2P network NW allowing peer-to-peer type communication between the multiple peers PN are not grouped.

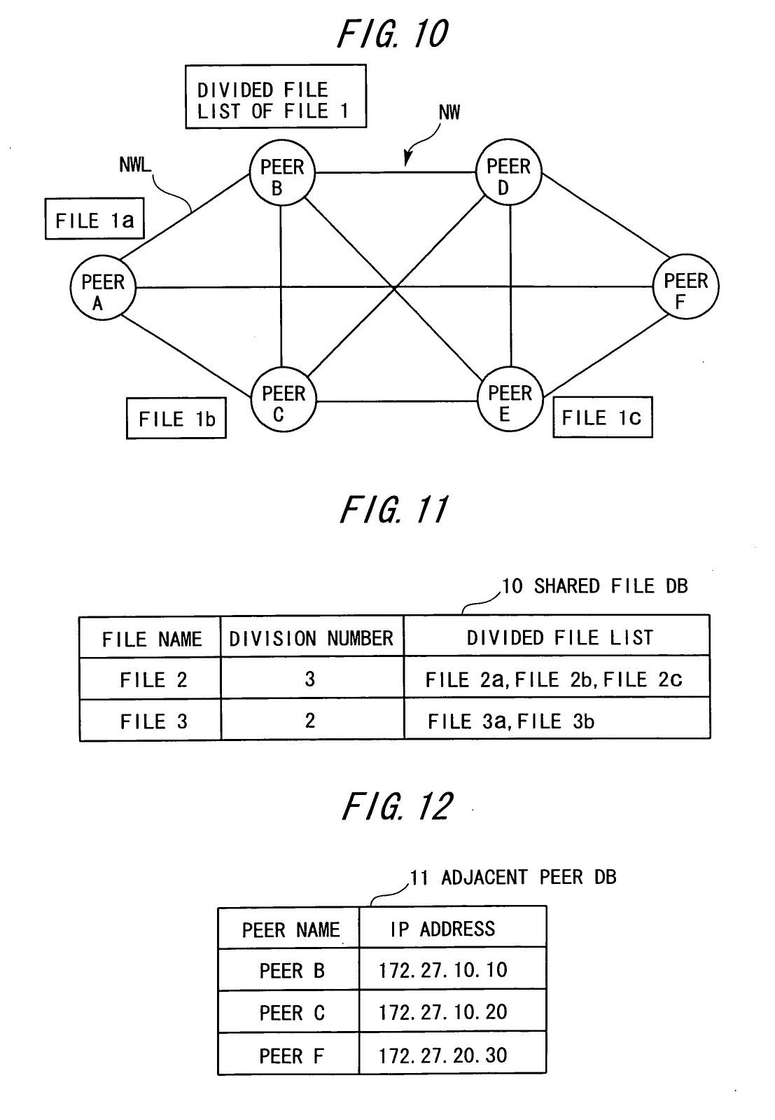

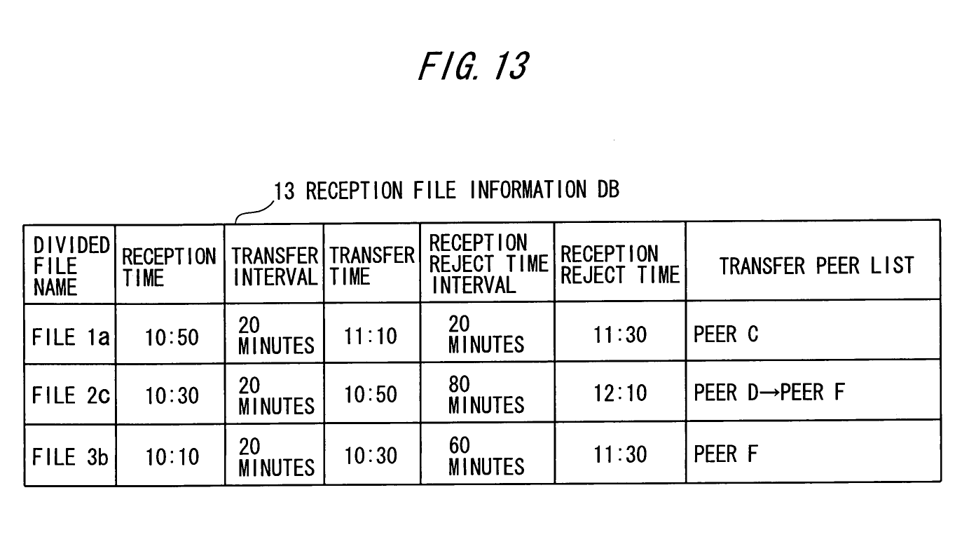

The file acquisition technique will be described with reference to a construction of the P2P network NW shown in FIG. 10, a construction of the shared file DB 10 shown in FIG. 11, a construction of the adjacent peer DB 11 shown in FIG. 12, and a construction of the reception file information DB 13 shown in FIG. 13 as well as FIGS. 1 to 4.

In this example, it is assumed that in the construction of the P2P network NW shown in FIG. 10, the peer B has divided a share target file FL1 (file 1) into three files FL1a, FL1b, and FL1c (files 1a, 1b, and 1c) for sharing. Also, it is assumed that at 11 o'clock (11:00), the peer A receives a request to search for the shared file 1 from a user and starts processing for acquiring the file 1. Further, it is assumed that at the point in time when the file search is started (11:00 o'clock) the respective divided files that are the file 1a, the file 1b, and the file 1c exist (is held or possessed) in the peer A, the peer C, and the peer E, respectively.

(1) Search for Divided File List (in Peer A)

When a user using a user terminal TE accommodated in the peer A wishes to acquire the shared file 1, he/she requests the shared file search means 4 to search for the file 1 from the user terminal TE through the user interface means 1. On receiving the request to search for the file 1 from the user through the user interface means 1, the shared file search means 4 inquires of the shared file management means 2 about whether the divided file list of the file 1 is possessed.

On receiving this inquiry, the shared file management means 2 refers to the shared file DB 10 (see FIG. 11) and searches for an entry corresponding to the file 1. In the shared file DB 10, an entry is created only for each file that was possessed and divided/transferred for sharing in the own peer. In this example, the peer that performed the division and sharing processing on the file 1 is the peer B, so that the entry corresponding to the file 1 does not exist in the shared file DB 10.

(2) Search for Divided File List (Between Peers)

When the shared file information on the file 1 was not detected by the shared file management means 2 of the peer A, the shared file search means 4 then requests the transmission and reception control means 5 to transmit a message to search for the shared file information on the file 1 to other peers.

On receiving this request, the transmission and reception control means 5 inquires of the transfer peer search means 6 about every piece of adjacent peer information. In response to this inquiry, the transfer peer search means 6 refers to the adjacent peer DB 11 (see FIG. 12) and returns the IP addresses of the registered peers B, C, and F to the transmission and reception control means 5. Then, the transmission and reception control means 5 transmits a shared file search message concerning the file 1 to the adjacent peers B, C, and F.

In each of the adjacent peers B, C, and F received this search message, the transmission and reception control means 5 inquires of the shared file management means 2 about a possessing state, that is, whether the shared file information on the file 1 is possessed in the own peer through the shared file search means 4. In this example, the shared file management means 2 of the peer B informs the transmission and reception control means 5 of the own peer B that the shared file information on the file 1 is possessed. Consequently, the transmission and reception control means 5 of the peer B transfers the shared file information on the file 1 to the peer A.

The transmission and reception control means 5 of the peer A receives the shared file information on the file 1 and passes the shared file information on the file 1 to the shared file search means 4.

(3) Search for Divided File (in Peer A)

The shared file search means 4 of the peer A refers to the divided file list in the shared file information received from the transmission and reception control means 5 and acquires a list of files that are necessary to restore the file 1. Then, the shared file search means 4 inquires of the reception file information management means 7 about whether any of the divided files 1a, 1b, and 1c on the divided file list is possessed in the own peer.

On receiving the divided file inquiry from the shared file search means 4, the reception file information management means 7 refers to the reception file information DB 13 (see FIG. 13) and searches for an entry corresponding to any of the divided files 1a, 1b, and 1c. As a result of this search, an entry corresponding to the file 1a is found in the reception file information DB 13. Then, the reception file information management means 7 confirms the transfer time in the detected entry corresponding to the file 1a. In this example, the transfer time “11:10” in the corresponding entry succeeds the current time “11:00”, so that it is found that the file 1a is not yet transferred, that is, the file 1a exists in the own peer. Consequently, the reception file information management means 7 acquires the divided file 1a from the reception file information DB 13 and passes it to the shared file search means 4.

(4) Search for Divided File (Between Peers)

After receiving a result of the search from the reception file information management means 7 in the peer A, the shared file search means 4 requests the transmission and reception control means 5 to transmit a message to search for the divided files 1b and 1c to other peers in order to obtain the divided files 1b and 1c other than the detected divided file 1a.

On receiving the request, the transmission and reception control means 5 inquires of the transfer peer search means 6 about every piece of adjacent peer information. In response to this inquiry, the transfer peer search means 6 returns the IP addresses of the peers B, C, and F registered in the adjacent peer DB 11 (see FIG. 12) to the transmission and reception control means 5. Then, the transmission and reception control means 5 transmits the message to search for the file 1b and the file 1c to the adjacent peers B, C, and F through the lines NWL of the P2P network NW.

In each of the adjacent peers B, C, and F received the search message, the transmission and reception control means 5 inquires of the reception file information management means 7 about a possessing state, that is, whether the file 1b or 1c is possessed in the own peer. In the peer C, the reception file information management means 7 informs the transmission and reception control means 5 that the file 1b exists in the own peer. Then, the transmission and reception control means 5 transfers the file 1b to the peer A through the line NWL.

Then, each of the adjacent peers B, C, and F further transmits the search message to its adjacent peers. This search message is repeatedly transferred a predetermined number of times. As a result of this repetitive transfer of the search message, the peer E receives the search message issued by the peer A from its adjacent peer after a while. In the peer E, the reception file information management means 7 informs the transmission and reception control means 5 that the file 1c exists in the own peer. Then, the transmission and reception control means 5 transfers the file 1c to the peer A through the line NWL.

(5) Restoration of Shared File (in Peer A)

After receiving the file 1b from the peer C and receiving the file 1c from the peer E, the transmission and reception control means 5 of the peer A passes those files 1b and 1c to the shared file search means 4. After acquiring all of the divided files 1a, 1b, and 1c that are necessary to restore the file 1 in this manner, the shared file search means 4 passes the divided files 1a, 1b, and 1c to the file restoration means 8.

The file restoration means 8 restores the file 1 based on the divided files 1a, 1b, and 1c and returns the restored file 1 to the shared file search means 4. Then, the shared file search means 4 provides the user terminal TE with the file 1 (requested shared file) through the user interface means 1 and the line NWL.

### THIRD SPECIFIC EXAMPLE

Next, a third specific example in the P2P network system SYS according to one embodiment of the present invention shown in FIG. 1 will be described.

As the third specific example, a file division and sharing technique will be described with which under a condition where the multiple peers PN are grouped, a share target file (file to be shared) is divided/transferred and shared in the P2P network NW allowing peer-to-peer type communication between the multiple peers PN. In this example, multiple groups of the multiple peers PN are formed (grouping of the peers is performed) in the P2P network NW and each divided file is sequentially transferred in one of the multiple groups. Each peer PN belongs to only one group and is incapable of belonging to multiple groups.

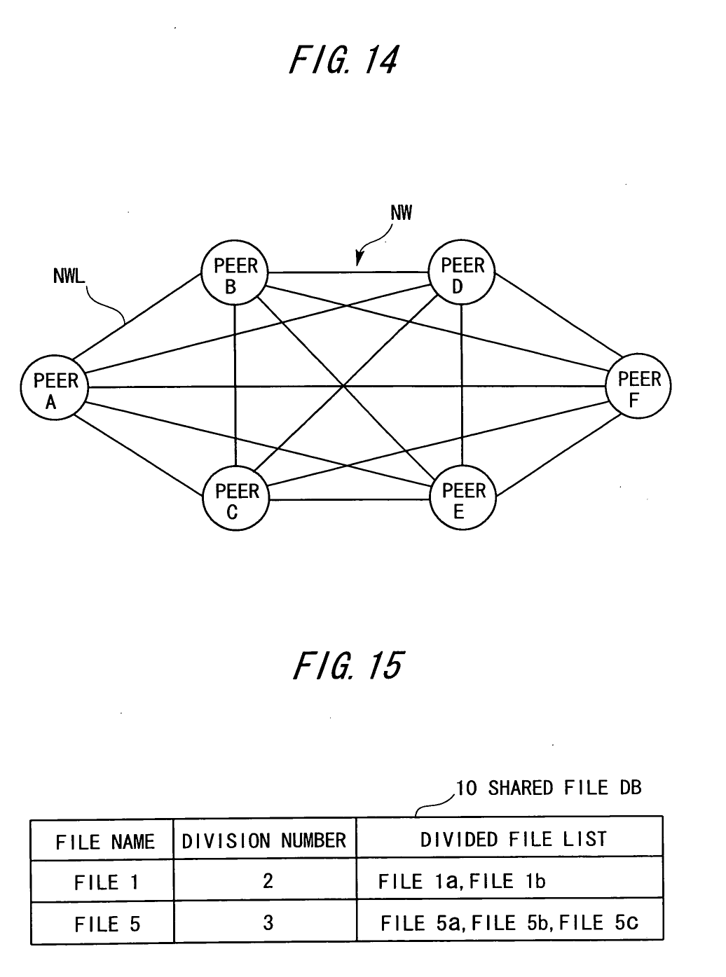

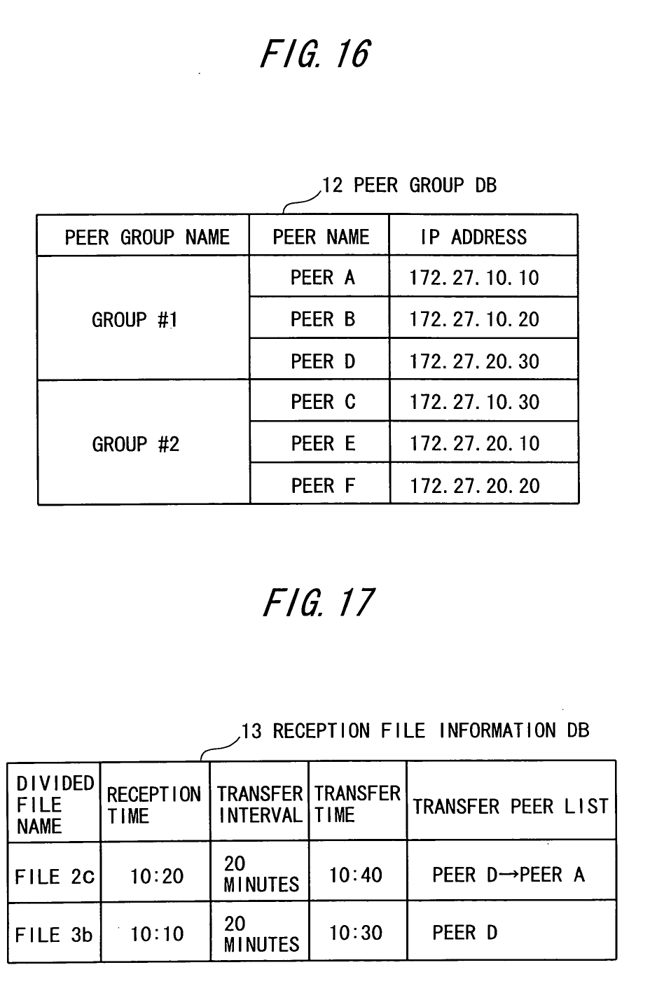

This file division and sharing technique will be described with reference to a construction of the P2P network NW shown in FIG. 14, a construction of the shared file DB 10 shown in FIG. 15, a construction of the peer group DB 12 shown in FIG. 16, and a construction of the reception file information DB 13 shown in FIG. 17 as well as FIGS. 1 to 4.

In this example, it is assumed that the peer A divides a share target file, thereby starting processing for sharing the file. Also, it is assumed that each peer A to F is not allowed to possess (save) two or more files (divided files or fragmented files) obtained through the division of the share target file at the same time. Further, it is assumed that for a predetermined certain period of time after the reception of a divided file of the share target file, it is impossible to receive the same divided file or another divided file. Still further, it is assumed that each group, to which one of the peers A to F belongs, is one of a group #1 and a group #2, with the peers A, B, and D belonging to the group #1 and the peers C, E, and F belonging to the group #2.

(1) Division of File (in Peer A)

When a user using a user terminal TE accommodated in the peer A wishes to share a share target file FL 1 (file 1) while maintaining the security of this file 1, he/she instructs the shared file management means 2 to share the file 1 from the user terminal TE through the user interface means 1. Then, the shared file management means 2 requests the file division means 3 to divide the file 1.

Fundamentally, the file division means 3 divides the share target file in a form where data (information) contained in each divided file makes no sense by itself. In this example, the file division means 3 divides the file 1 into a first file F1a (file 1a) corresponding to a result of extraction of only even bits of the file (more strictly, file constituent data) and a second file F1b (file 1b) corresponding to a result of extraction of only odd bits of the file.

Then, the file division means 3 adds a header to each of those divided files 1a and 1b. The information contained in this header is a file transfer time interval, a divided file list, and a transfer peer list. The file transfer time interval is a period of time between the reception of the divided file by a certain peer and the transfer to the next peer. As to the shared file 1 in this example, the file transfer time interval is set at “10 minutes”.

Also, the divided file list is a list of the divided files that are necessary to restore the shared file. In more detail, the file 1a and the file 1b are on this divided file list. The transfer peer list is a list of peers through which the divided file has passed as a result of transfer based on the file transfer time interval. In this example, previous two reception peers are saved on the transfer peer list, with the oldest reception peer being at the start of the list.

(2) Registration of File Division Information (in Peer A)

After the division of the share target file 1, the file division means 3 of the peer A passes the pre-division file (file 1) and the post-division files (files 1a and 1b) to the shared file management means 2. Then, the shared file management means 2 registers information concerning the divided files 1a and 1b of the file 1 in the shared file DB 10 (see FIG. 15).

The shared file DB 10 is a database giving the division information concerning each file provided by the own peer and shared in the P2P network NW. In the shared file DB 10, each division number is the number of divided files of a shared file and each divided file list is a list of the names of post-division files of a shared file. The divided file list is referred to at the time of restoration of the shared file.

When the registration of the file division information into the shared file DB 10 is completed, the shared file management means 2 deletes the pre-division file (file 1), passes the post-division files (files 1a and 1b) and the file division information to the transmission and reception control means 5, and requests the transfer of the divided files.

(3) Search for Transfer Destination Peer (in Peer A)

On receiving the request to transfer the divided files from the shared file management means 2, the transmission and reception control means 5 requests the transfer peer search means 6 to search for divided file transfer destination peers. On receiving this search request, the transfer peer search means 6 searches for the divided file transfer destination peers. In order to transfer the respective divided files to mutually different groups, the transfer peer search means 6 needs to select one peer from each group. In order to select peers whose number is equal to the number of the divided files, the transfer peer search means 6 refers to the peer group DB 12 (see FIG. 16) that manages the peers belong to each peer group and randomly selects one peer from each peer group.

The peer group DB 12 is a database where each peer existing in the P2P network NW, the group to which the peer belongs, and the IP address of the peer are registered. In this example, at the time when each peer takes part in the P2P network NW, the contents of the peer group DB 12 are registered. It does not matter whether this peer group DB 12 is held in each peer or is held in a Hybrid P2P management server. When the peer group DB 12 is held in the management server, the transfer peer search means 6 sends an inquiry to the management server through the transmission and reception control means 5 and the line NWL of the P2P network NW. In this example, the transfer peer search means 6 selects the peer B from the group #1 and selects the peer C from the group #2 and passes the IP addresses of the peers B and C to the transmission and reception control means 5.

It should be noted here that a peer group search means that is dedicated to this transfer destination peer search processing may be provided between the transfer peer search means 6 and the peer group DB 12. In this case, through cooperation between the peer group search means and the transfer peer search means 6, the processing for searching for the transfer destination peers is carried out.

(4) Transfer of File (Negotiation with Transfer Destination-Peer B)

In order to transmit the divided file 1a to the peer B and to transmit the divided file 1b to the peer C through the lines NWL of the P2P network NW, the transmission and reception control means 5 of the peer A first transmits the file name and header information of the file 1a to the peer B and transmits the file name and header information of the file 1b to the peer C. The processing in the peer B and the processing in the peer C are the same, so that in the following description, only the processing in the peer B will be explained.

On receiving the file name and the header information from the peer A through the line NWL, the transmission and reception control means 5 of the peer B passes the transfer peer list in the header to the reception file information management means 7. Then, the reception file information management means 7 refers to the reception file information DB 13 (see FIG. 17) and confirms that the file 1a does not exist. The reception file information DB 13 is a database composed of multiple columns named “divided file name”, “file reception time”, “file transfer time interval (transfer interval)”, “file transfer time”, and “transfer peer list” and is used to manage the transfer time of each received divided file to the next peer and to determine whether the reception of a divided file of a certain shared target file is approved or rejected.

In addition, the reception file information management means 7 confirms that the own peer (peer B) is not contained in the transfer peer list of the header information. Following this, the reception file information management means 7 informs the transmission and reception control means 5 that the reception is permitted. Then, the transmission and reception control means 5 returns a reception permission notification to the peer A through the line NWL.

On receiving the reception permission notification from the peer B, the transmission and reception control means 5 of the peer A transmits the file 1a to the peer B.

(5) Reception of File (Processing in Peer B)

After receiving the divided file 1a transmitted from the transmission and reception control means 5 of the peer A, the transmission and reception control means 5 of the peer B stores the received divided file 1a in a disk apparatus and then passes the file name, header information (file transfer time interval, transfer peer list) and file reception time of the received file to the reception file information management means 7.

The reception file information management means 7 registers the received file name, file reception time, and file transfer time interval and transfer peer list within the received file header of the received file as well as a transfer time calculated from those information in the reception file information DB 13. An example of the reception file information DB 13 after this registration processing is shown in FIG. 17.

Then, the reception file information management means 7 activates a timer for transfer of the file 1a based on the file transfer time interval in the received file header. When this timer has timed out, the reception file information management means 7 passes the name and the transfer peer list of the divided file obtained from the reception file information DB 13 to the transmission and reception control means 5 and requests the transfer of the file 1a to another peer.

(6) Transfer of File (Processing in Peer B)

On receiving the transfer request issued as a result of the time-out of the timer for the transfer of the divided file 1a, the transmission and reception control means 5 of the peer B passes the transfer peer list to the transfer peer search means 6 and requests a search for the next transfer peer.

In order to select a peer belonging to the same group based on the received transfer peer list, the transfer peer search means 6 refers to the peer group DB 12 and selects the peer D that belongs to the group (group #1), which is the same as the group to which the own peer belongs, and is not contained in the transfer peer list. When every peer in the same group is contained in the transfer peer list, the transfer peer search means 6 selects the oldest peer on the transfer peer list.

Then, the transfer peer search means 6 passes the peer name and the IP address of the selected peer D to the transmission and reception control means 5. After adding the own peer (peer B) to the transfer peer list of the file 1a, the transmission and reception control means 5 transmits the file 1a to the transfer destination peer D through the line NWL. When the number of peers registered on the transfer peer list has already reached a registration limit number (“2” in this example), the transmission and reception control means 5 deletes the oldest peer before adding the peer B. After the transfer to the peer D is completed, the transmission and reception control means 5 deletes the divided file 1a saved in a disk apparatus.

In this manner, the divided file 1a is moved from one peer to another each time a certain period of time has passed. As a result, it becomes possible to secure security.

### FOURTH SPECIFIC EXAMPLE

Next, a fourth specific example in the P2P network system SYS according to one embodiment of the present invention shown in FIG. 1 will be described.

As the fourth specific example, a file acquisition technique will be described with which a file divided/transferred and shared with the same file division and sharing technique as in the third specific example described above is searched for and acquired. Like in the third specific example, this fourth specific example will be described under a condition where the multiple peers PN in the P2P network NW allowing peer-to-peer type communication between the multiple peers PN are grouped.

In this example, multiple groups of the multiple peers PN are formed (grouping of the peers is performed) in the P2P network NW. Each peer PN belongs to only one group and is incapable of belonging to multiple groups. Also, it is assumed that each group, to which one of the peers PN belongs, is one of a group #1 and a group #2.

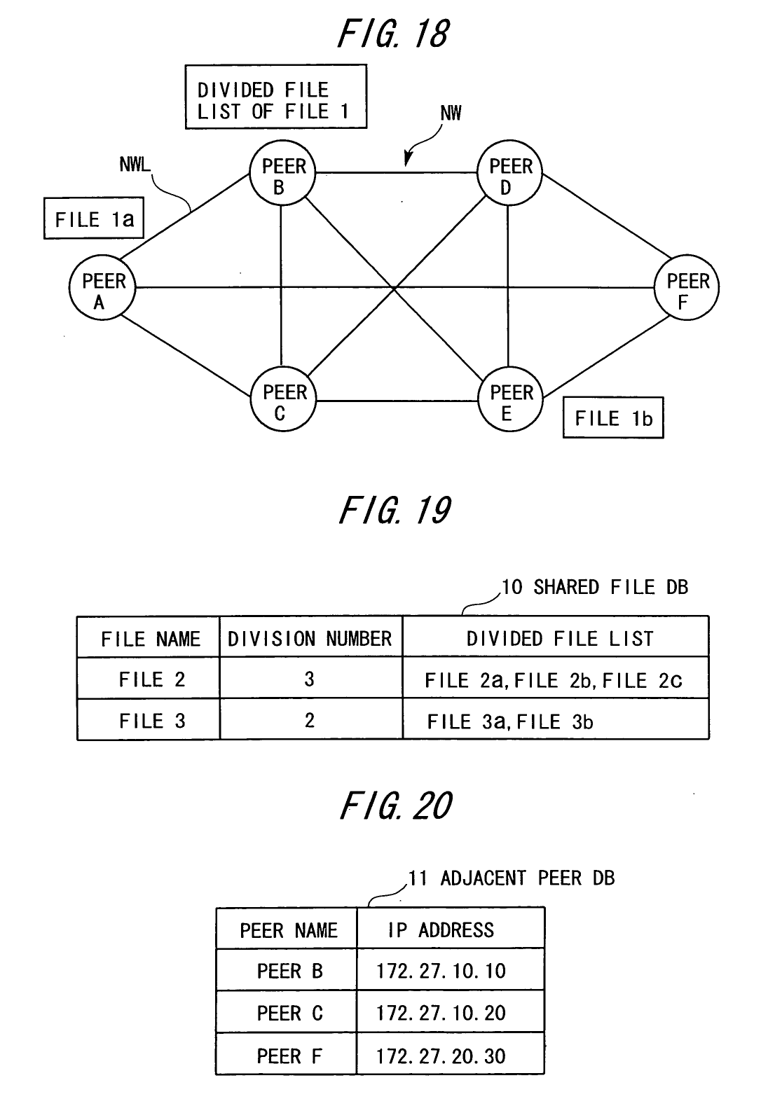

The file acquisition technique will be described with reference to a construction of the P2P network NW shown in FIG. 18, a construction of the shared file DB 10 shown in FIG. 19, a construction of the adjacent peer DB 11 shown in FIG. 20, and a construction of the reception file information DB 13 shown in FIG. 22 as well as FIGS. 1 to 4.

In this example, it is assumed that in the construction of the P2P network NW shown in FIG. 18, the peer B has divided a share target file FL1 (file 1) into two files FL1a and FL1b, (files 1a and 1b) for sharing. Also, it is assumed that at 11 o'clock (11:00), the peer A receives a request to search for the shared file 1 from a user and starts processing for acquiring the file 1. Further, it is assumed that at the point in time when the file search is started (11:00 o'clock), the respective divided files that are the file 1a and the file 1b exist (is held or possessed) in the peer A and the peer E, respectively. In addition, the peer A, B, and D belong to Group #1, and the peer C, E, and F belong to Group #2.

(1) Search for Divided File List (in Peer A)

When a user using a user terminal TE accommodated in the peer A wishes to acquire the shared file 1, he/she requests the shared file search means 4 to search for the file 1 from the user terminal TE through the user interface means 1. On receiving the request to search for the file 1 from the user through the user interface means 1, the shared file search means 4 inquires of the shared file management means 2 about whether the divided file list (shared file information) of the file 1 is possessed.

The shared file management means 2 refers to the shared file DB 10 (see FIG. 19) and searches for an entry corresponding to the file 1. In the shared file DB 10, an entry is created only for each file that was possessed and divided/transferred for sharing in the own peer. In this example, the peer that performed the division and sharing processing on the file 1 is the peer B, so that the entry corresponding to the file 1 does not exist in the shared file DB 10.

(2) Search for Divided File List (Between Peers)

When the shared file information on the file 1 was not detected by the shared file management means 2 of the peer A, the shared file search means 4 then requests the transmission and reception control means 5 to transmit a message to search for the shared file information on the file 1 to other peers.

On receiving this request, the transmission and reception control means 5 inquires of the transfer peer search means 6 about every piece of adjacent peer information. In response to this inquiry, the transfer peer search means 6 refers to the adjacent peer DB 11 (see FIG. 20) and returns the IP addresses of the registered peers B, C, and F to the transmission and reception control means 5. Then, the transmission and reception control means 5 transmits a shared file search message concerning the file 1 to the adjacent peers B, C, and F.

In each of the adjacent peers B, C, and F received this search message, the transmission and reception control means 5 inquires of the shared file management means 2 about a possessing state, that is, whether the shared file information on the file 1 is possessed in the own peer through the shared file search means 4. In this example, the shared file management means 2 of the peer B informs the transmission and reception control means 5 of the own peer B that the shared file information on the file 1 is possessed. Consequently, the transmission and reception control means 5 of the peer B transfers the shared file information on the file 1 to the peer A.

The transmission and reception control means 5 of the peer A receives the shared file information on the file 1 and passes the shared file information on the file 1 to the shared file search means 4.

(3) Search for Divided File (in Peer A)

The shared file search means 4 of the peer A refers to the divided file list in the shared file information received from the transmission and reception control means 5 and acquires a list of files that are necessary to restore the file 1. Then, the shared file search means 4 inquires of the reception file information management means 7 about whether any of the divided files 1a and 1b on the divided file list is possessed in the own peer.

On receiving the divided file inquiry from the shared file search means 4, the reception file information management means 7 refers to the reception file information DB 13 (see FIG. 22) and searches for an entry corresponding to any of the divided files 1a and 1b. As a result of this search, an entry corresponding to the file 1a is found in the reception file information DB 13. Existence of the entry means the existence of the divided file 1a exists in the own peer.

In other words, the reception file information management means 7 confirms the transfer time in the detected entry of the file 1a. The transfer time “11:10” in the corresponding entry succeeds the current time “11:00”, so that it is found that the file 1a is not yet transferred, that is, the file 1a exists in the own peer. Consequently, the reception file information management means 7 acquires the divided file 1a from the reception file information DB 13 and passes it to the shared file search means 4.

(4) Search for Divided File (Between Peers)

After receiving a result of the search from the reception file information management means 7 in the peer A, the shared file search means 4 requests the transmission and reception control means 5 to transmit a message to search for the divided file 1b to other peers in order to obtain the divided file 1b other than the detected divided file 1a.

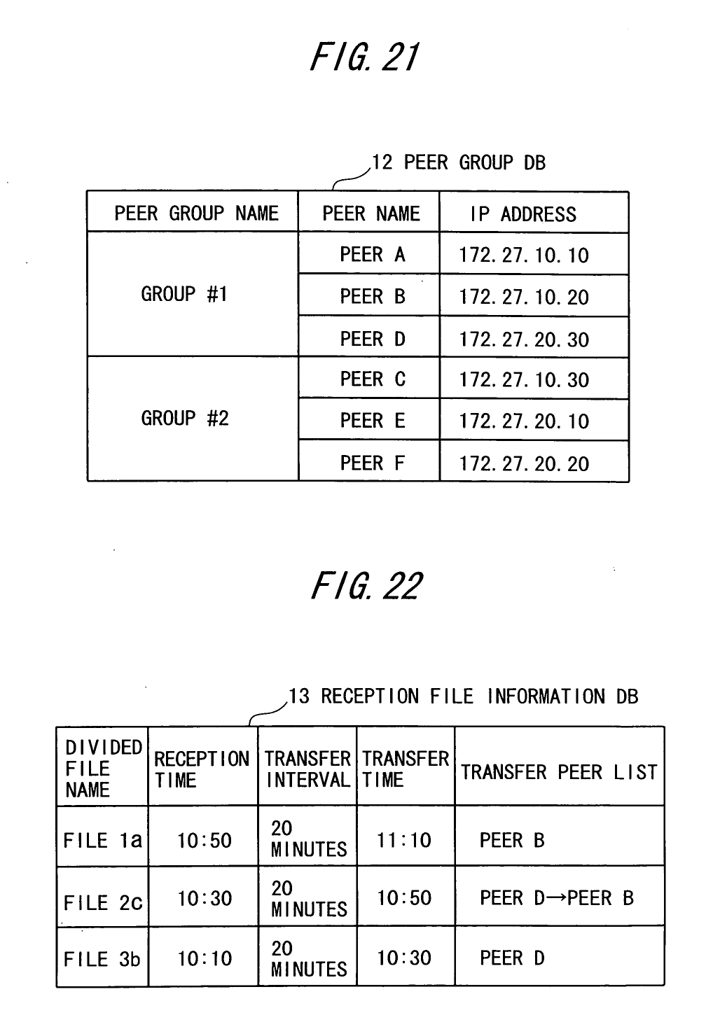

On receiving the search message, the transmission and reception control means 5 inquires of the transfer peer search means 6 about every piece of peer group information. Then, the transfer peer search means 6 randomly selects one peer from each group registered in the peer group DB 12 shown in FIG. 21 and returns the selected peer to the transmission and reception control means 5. In this example, the peer D is selected from the group #1 and the peer F is selected from the group #2. Then, the transmission and reception control means 5 transmits the message to search for the file 1b to the peers D and F through the lines NWL.

In each of the peers D and F received the search message from the peer A, the transmission and reception control means 5 inquires of the reception file information management means 7 about a possessing state, that is, whether the file 1b is possessed in the own peer. In response to this inquiry, the reception file information management means 7 refers to the reception file information DB 13 and searches for an entry corresponding to the file 1b.

If the entry exists, the reception file information management means 7 informs the transmission and reception control means 5 that the file 1b exists in the own peer. Then, the transmission and reception control means 5 transfers the file 1b to the peer A through the line NWL. On the other hand, if the entry does not exist, the transfer peer search means 6 selects every peer belonging to the same group from the peer group DB 12 and the transmission and reception control means 5 cooperating with the transfer peer search means 6 transfers the search message to every peer in the group.

On receiving the search message from the peer F, the reception file information management means 7 in the peer E informs the transmission and reception control means 5 that the file 1b exists in the own peer. Then, the transmission and reception control means 5 transfers the file 1b to the peer A through the line NWL.

(5) Restoration of Shared File (in Peer A)

After acquiring the divided files 1a and 1b that are necessary to restore the shared file 1 in this manner, the transmission and reception control means 5 in the peer A passes those divided files 1a and 1b to the shared file search means 4. Then, the shared file search means 4 passes the received divided files 1a and 1b to the file restoration means 8.

The file restoration means 8 restores the file 1 based on the divided files 1a and 1b, and returns the restored file 1 to the shared file search means 4. As a result, the shared file search means 4 provides the user terminal TE with the file 1 (requested shared file) through the user interface means 1 and the line NWL.

[Modification]

In the embodiment described above, the multiple peers constituting the P2P network NW may possess (save) files (divided files or fragmented files) obtained through the division of a certain share target file in a dual manner. In this case, it becomes possible to restore the original file even when mobile terminals (such as laptop personal computers) constitute the peers and any of the mobile terminals is stolen or lost.

Also, it is possible to carry out the present invention with a program that causes a computer to execute the processing described in the embodiment. In this case, it is possible to provide the program by using a recording medium, such as a CD-ROM or a flexible disk, or through a communication line.

Further, it is possible to carry out the present invention by selecting arbitrary ones or all of the respective operations described in the embodiment and combining them with each other.

### INDUSTRIAL APPLICABILITY

The present invention is applicable, for instance, to an electronic document file containing confidential information shared for a project in a company or the like.

1. A peer node for constructing a peer-to-peer (P2P) network allowing P2P type communication, comprising:
a unit dividing a share target file for information sharing through the P2P network into a plurality of divided files in a form where contents of each divided file makes no sense by itself;
a unit distributing and arranging the plurality of divided files to and in a plurality of peer nodes including an own peer node and at least one other peer node constituting the P2P network; and
a unit moving each of the divided files of distribution and arrangement between the plurality of peer nodes at a certain period of time.

2. A peer node according to claim 1,
wherein the dividing unit divides the share target file into at least one first divided file containing only even bits of file constituent data and at least one second divided file containing only odd bits of the file constituent data.

3. A peer node according to claim 1, further comprising:
an interface unit enabling registration of and a search for the share target file from a user terminal;
a first management unit managing division information concerning the share target file inputted through the interface unit and divided by the dividing unit using a first storage unit;
a first search unit performing, with respect to the share target file requested from the user terminal through the interface unit, a search of the first storage unit in the own peer node and creating a search message to be transmitted to the at least one other peer node;
a first control unit exchanging the plurality of divided files of the share target file registered by the first management unit and the search message created by the first search unit with the at least one other peer node;
a second search unit searching for transmission destination peer node information requested from the first control unit by using a second storage unit storing adjacent peer node information;
a second management unit managing each divided file received by the first control unit using a third storage unit storing reception file information, judging whether each file transfer request from another peer node should be approved or rejected, and requesting the first control unit to transfer the received divided file when a current time has reached a transfer time set for the received divided file; and
a restoration unit restoring the share target file based on the plurality of divided files collected by the first search unit.

4. A peer node according to claim 3, further comprising:
a third search unit searching, when the plurality of peer nodes are divided into a plurality of groups, for a transfer destination for each divided file by selecting one peer node from the same group,
wherein the divided files are distributed to and arranged in the plurality of peer nodes, including the own peer node and at least one other peer node constituting the P2P network, every the plurality of groups and are moved to another peer node in the same group at a certain period of time.

5. A peer node according to claim 4,
wherein the third search unit searches for transmission destination peer node information requested from the first control unit by using a fourth storage unit storing peer group information.

6. A method of dividing and sharing a file in a peer node for constructing a peer-to-peer (P2P) network allowing P2P type communication, the method comprising the steps of:
dividing a share target file for information sharing through the P2P network into a plurality of divided files in a form where contents of each divided file makes no sense by itself;
distributing and arranging the plurality of divided files to and in a plurality of peer nodes including an own peer node and at least one other peer node constituting the P2P network; and
moving each of the divided files of distribution and arrangement between the plurality of peer nodes at a certain period of time.

7. A method of dividing and sharing a file according to claim 6,
wherein the dividing step comprises dividing the share target file into at least one first divided file containing only even bits of file constituent data and at least one second divided file containing only odd bits of the file constituent data.

8. A method of dividing and sharing a file according to claim 6, further comprising:
an input step that enables registration of and a search for the share target file from a user terminal;
a first management step of managing division information concerning the share target file inputted through the input step and divided by the dividing step using a first storage unit;
a first search step of performing, with respect to the share target file requested from the user terminal through the input step, a search of the first storage unit in the own peer node and creating a search message to be transmitted to the at least one other peer node;
a first control step of exchanging the plurality of divided files of the share target file registered by the first management step and the search message created by the first search step with the at least one other peer node;
a second search step of searching for transmission destination peer node information requested from the first control step by using a second storage unit storing adjacent peer node information;
a second management step of managing each divided file received by the first control step using a third storage unit storing reception file information, judging whether each file transfer request from another peer node should be approved or rejected, and requesting the first control step to transfer the received divided file when a current time has reached a transfer time set for the received divided file; and
a restoration step of restoring the share target file based on the plurality of divided files collected by the first search step.

9. A method of dividing and sharing a file according to claim 8, further comprising:
a third search step of searching, when the plurality of peer nodes are divided into a plurality of groups, for a transfer destination for each divided file by selecting one peer node from the same group,
wherein the divided files are distributed to and arranged in the plurality of peer nodes, including the own peer node and at least one other peer node constituting the P2P network, every the plurality of groups and are moved to another peer node in the same group at a certain period of time.

10. A method of dividing and sharing a file according to claim 9,
wherein the third search step searches for transmission destination peer node information requested from the first control step by using a fourth storage unit storing peer group information.
